(19) United States
(12) Patent Application Publication
(10) Pub. No.: US 2003/0236813 A1
(43) Pub. Date: Dec. 25, 2003

(54) Method and apparatus for off-load processing of a message stream

(76) Inventor: John B. Abjanic, San Diego, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/178,997

(22) Filed: Jun. 24, 2002

(51) Int. Cl. G06F 9/00

(52) U.S. Cl. 709/102

(57) ABSTRACT

A system including a number of off-load devices coupled with an off-load controller. The off-load controller parses an incoming message stream looking for off-loadable tasks that, if detected, are off-loaded to one of the off-load devices for processing.

### FIELD

Embodiments of the invention relate generally to computer networking and, more particularly, to a system and method for off-loading the processing of a task or operation from an application server, or server cluster, to an off-load device.

### BACKGROUND

To increase the capacity of a web site, it is common to deploy a plurality of servers, or a server cluster, at the host site. An exemplary embodiment of a conventional server hosting system 100 including such a server cluster is illustrated in FIG. 1. The server hosting system 100 includes a plurality of servers 180—including servers 180a, 180b, . . . , 180n—that are coupled with a switch and load balancer 140 (which, for ease of understanding, will be referred to herein as simply a “switch”). Each of the servers 180a-n is coupled with the switch 140 by a link 160 providing a point-to-point connection therebetween. The switch 140 is coupled with a router 20 that, in turn, is coupled with the Internet 5. The server cluster 180a-n is assigned a single IP (Internet Protocol) address, or virtual IP address (VIP), and all network traffic destined for—or originating from—the server cluster 180a-n flows through the switch 140. See, e.g., Internet Engineering Task Force Request For Comment (IETF RFC) 791, Internet Protocol. The server cluster 180a-n, therefore, appears as a single network resource to those clients 10 who are accessing the server hosting system 100.

When a client 10 attempts to establish a connection with the server hosting system 100, a packet including a connection request—e.g., TCP (Transmission Control Protocol) SYN—is received at the router 20, and the router 20 transmits the packet to the switch 140. See, e.g., IETF RFC 792, Transmission Control Protocol. The switch 140 will select one of the servers 180a-n to process the client's request and, to select a server 180, the switch 140 employs a load balancing mechanism to balance client requests among the plurality of servers 180a-n. The switch 140 may employ “transactional” load balancing, wherein a client request is selectively forwarded to a server 180 based, at least in part, upon the load on each of the servers 180a-n. Alternatively, the switch 140 may employ “application-aware” or “content-aware” load balancing, wherein a client request is forwarded to a server 180 based upon the application associated with the request—i.e., the client request is routed to a server 180, or one of multiple servers, that provides the application (e.g., web services) initiated or requested by the client 10. Also, rather than employ one of the above-described load balancing schemes, the switch 140 may simply distribute client requests amongst the servers 180a-n in a round robin fashion.

The performance of a web site can be improved by employing such a server cluster 180a-n in conjunction with one or more load balancing mechanisms, as described above. The workload associated with processing client requests is distributed amongst all servers 180 in the cluster 180a-n. However, the server cluster 180a-n may still become overwhelmed by the processing of commonly occurring and/or often needed tasks. Examples of such commonly occurring tasks include content-aware routing decisions (as part of a content-aware load balancing scheme), user authentication and verification, as well as XML processing operations such as, for example, validation and transformation. See, e.g., Extensible Markup Language (XML) 1.0, 2^{nd} Edition, World Wide Web Consortium, October 2000.

Generally, the above-described tasks, as well as others, are executed each time a client requests a connection with a website's host server—e.g., as may occur for user authentication—or upon receipt of each packet (or stream of packets) at the server hosting system—e.g., as may occur for content routing decisions—irrespective of the particular services and/or resources being requested by the client. Thus, these operations are very repetitive in nature and, for a heavily accessed website, such operations may place a heavy burden on the host application servers. This burden associated with handling commonly occurring tasks consumes valuable but limited processing resources available in the host server cluster and, accordingly, may result in increased latency for handling client requests and/or increased access times for clients attempting to access a web site.

### BRIEF DESCRIPTION OF THE DRAWINGS

FIG. 1 is a schematic diagram illustrating an exemplary embodiment of a conventional server hosting system.

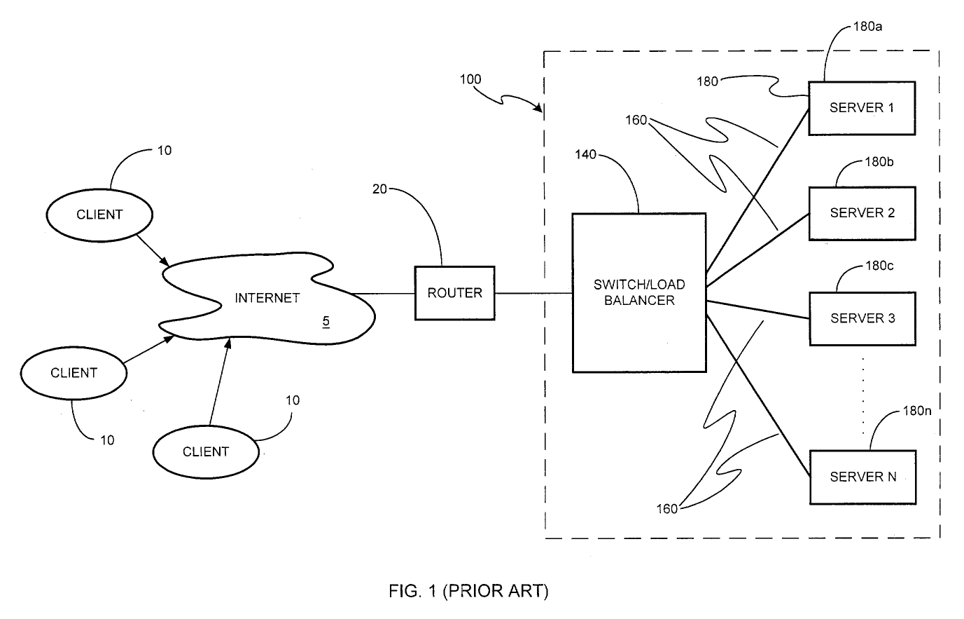

FIG. 2 is a schematic diagram illustrating an embodiment of a server hosting system including a number of off-load devices.

FIG. 3 is a schematic diagram illustrating an embodiment of an off-load controller.

FIG. 4 is a block diagram illustrating an embodiment of a method of off-loading tasks.

FIG. 5 is a block diagram illustrating another embodiment of the method of off-loading tasks.

FIG. 6 is a schematic diagram illustrating an embodiment of a server hosting system including a number of XML off-load devices.

FIG. 7 is a block diagram illustrating an embodiment of a method of off-loading XML tasks.

### DETAILED DESCRIPTION

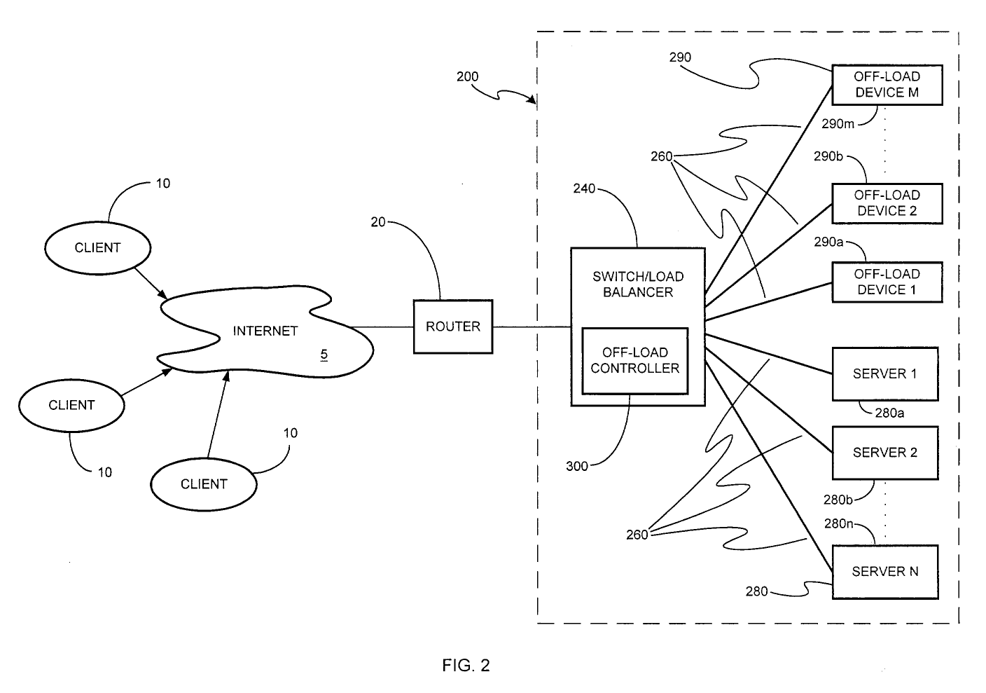

An embodiment of a server hosting system 200 is illustrated in FIG. 2. The server hosting system 200 includes a number of off-load devices 290, each off-load device dedicated to performing a selected task or set of tasks, as will be explained below. Accordingly, execution of these selected operations is off-loaded from an application server or servers 280 of server hosting system 200, thereby conserving computing resources and allowing more resources to be dedicated to handling client transactions. Therefore, by off-loading one or more tasks from the primary application server, or server cluster, to the off-load devices 290—especially for often-needed and highly repetitive tasks—the latency associated with servicing client requests, as well as client access time, are reduced.

Referring to FIG. 2, the server hosting system 200 is coupled with a router 20 that, in turn, is coupled with the Internet 5 or other network. The router 20 may comprise any suitable routing device known in the art, including any commercially available, off-the-shelf router. The server hosting system 200 is accessible by one or more clients 10 that are connected with the Internet 5. Although the server hosting system 200 is illustrated as being coupled with the Internet 5, it should be understood that the server hosting system 200 may be coupled with any computer network, or plurality of computer networks. By way of example, the server hosting system 200 may be coupled with a Local Area Network (LAN), a Wide Area Network (WAN), and/or a Metropolitan Area Network (MAN).

The server hosting system 200 includes a switch and load balancer 240, which is coupled with the router 20. For ease of understanding, the switch and load balancer 240 will be referred to herein as simply a “switch.” The switch 240 includes, or is coupled with, an off-load controller 300. Operation of the off-load controller 300 will be explained in detail below. The server hosting system 200 also includes one or more servers 280, including servers 280a, 280b, . . . , 280n. Each of the servers 280a-n is coupled with the switch 240 by a link 260 providing a point-to-point connection therebetween. Alternatively, a network (not shown in figures) may coupled the servers 280a-n with the switch 240.

A server 280 may comprise any suitable server or other computing device known in the art, including any one of numerous commercially available, off-the-shelf servers. The server cluster 280a-n is assigned a single IP (Internet Protocol) address, or virtual IP address (VIP), and all network traffic destined for—or originating from—the server cluster 280a-n flows through the switch 240. The server cluster 280a-n, therefore, appears as a single network resource to those clients 10 who are accessing the server hosting system 200.

Also coupled with the switch 240 are a number of off-load devices 290, including off-load devices 290a, 290b, . . . , 290m. Each of the off-load device 290a-m is coupled with the switch 240 by a link 260 providing a point-to-point connection therebetween. Alternatively, the off load devices 290a-m may be coupled with the switch 240 by a network (not shown in figures). Any suitable number of off-load devices 290 may be coupled with the switch 240. The architecture of server hosting system 200 is scalable and fault-resistant. If additional off-load processing capability is needed, an appropriate number of off-load devices 290 may simply be added to the server hosting system 200 and, if one of the off-load devices 290a-m fails, there will be no disruption in operation of the server hosting system 200, as the failed device's workload can be distributed amongst the remaining off-load devices 290.

Each off-load device 290 comprises any suitable device or circuitry capable of receiving data and, in accordance with a command received from the switch 240, performing a task or operation on that data. A result may be determined by the off-load device 290, which result may, in turn, be provided to the off-load controller 300 and/or switch 240. Tasks that may be performed by an off-load device 290 include, by way of example only, content-aware routing decisions, user authentication and verification, XML validation, and XML transformation, as well as other operations. An off-load device 290 may, for example, comprise a microprocessor, an application specific integrated circuit (ASIC), or a field-programmable gate array (FPGA). It should be understood, however, that such an off-load device 290 may comprise a part of, or be integrated with, another device or system (e.g., a server). Further, it should be understood that an off-load device 290 may be implemented in hardware, software, or a combination thereof.

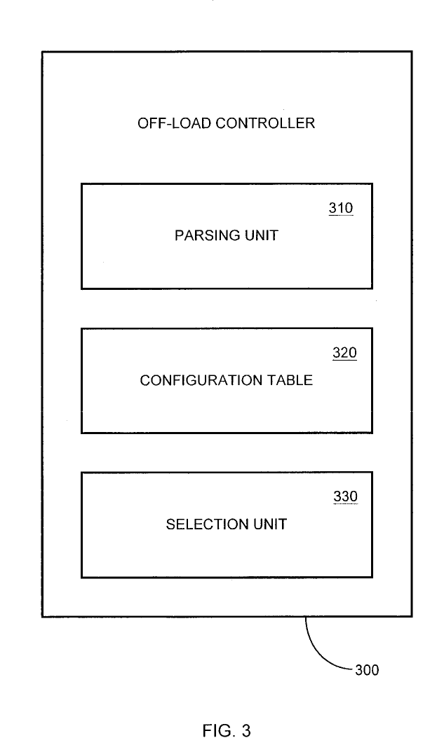

Referring now to FIG. 3, an embodiment of the off-load controller 300 is illustrated. The off-load controller 300 forms a part of, or is coupled with, the switch 240, as noted above. As shown in FIG. 3, the off-load controller 300 may include a parsing unit 310, a configuration table 320, and a selection unit 330.

When a message stream—i.e., a stream of one or more packets—is received from the Internet 5, the parsing unit 310 parses the incoming packets and “looks” for tasks that may be off-loaded to one of the off-load devices 290. To identify such a task, the parsing unit 310 may search for a data pattern that suggests a task that can be off-loaded. Alternatively, the incoming packet may include a call (e.g., a procedure call) or command indicating that the packet includes an operation that may be off-loaded to an off-load device 290, and the parsing unit 310 will search for such a call or command. It should be understood, however, that searching a received message stream for a data pattern or a call corresponding to an off-loadable task are merely examples of how an off-loadable task may be identified within a received message stream. Any other suitable method and/or device may be employed by the parsing unit 310 to identify an off-loadable task in a received message stream.

Any of the above-described tasks that may be off-loaded to an off-load device 290 will be referred to herein as an “off-loadable task” (or an “off-loadable operation”). A broad array of network processing tasks—e.g., content-aware routing decisions, user authentication and verification, XML validation, and XML transformation—may be off-loadable tasks. As noted above, these network processing tasks tend to be highly repetitive and, in conventional systems, these operations can heavily burden the server cluster 280a-n. There will typically be a predefined set of off-loadable tasks, and each of the off-loadable tasks can be handled by any one of the off-load devices 290 (i.e., each off-load device 290 can process any task). In an alternative embodiment, each off-loadable task is handled by a selected one of, or a selected set of, the off-load devices 290 (i.e., each off-load device 290 can process a specific task or a set of tasks).

If a data pattern in an incoming message stream matches or suggests one of the specified off-loadable tasks, or if a call is found in the incoming message stream indicating that an off-loadable task is to be performed, the off-loadable task will be performed by one of the off-load devices 290a-m. To process the off-loadable task, at least a portion of the data in the incoming message stream and a command are forwarded to one of the off-loadable devices 290a-m. The command (which is provided by the off-load controller 300 and/or switch 240) informs the receiving off-load device 290 which off-load task is to be performed on the packet data. For example, a look-up operation may be performed in the configuration table 320—which is described in detail below—to determine which command is to be forwarded with the packet data to the appropriate off-load device 290. As will be described below, the off-load device 290 that will receive the packet data and command is selected by the selection unit 330.

In one embodiment, the parsing unit 310 may parse network Layer 7 application data—e.g., such as the URI (Universal Resource Identifier)—of an incoming stream of packets searching for off-loadable tasks. See Internet Engineering Task Force Request for Comment (IETF RFC) 1630, Universal Resource Identifiers in WWW, June 1994. If a data pattern in the URI matches or suggests an off-loadable task, a look-up operation may be performed in the configuration table 320 to determine which command is to be forwarded with the packet data to the selected off-load device 290.

The configuration table 320 may construct or provide commands to the off-load devices 290a-m. The configuration table 320 may comprise a series of entries, each such entry identifying an off-loadable task (or a data pattern or call corresponding to an off-loadable task) and a command corresponding to that off-loadable task. The corresponding command is to be forwarded to a selected off-load device 290 if a data pattern or call indicative of that off-loadable task is detected in an incoming message stream. The command will direct the selected off-load device 290 as to what operation (e.g., user authentication, XML validation, etc.) is to be taken with respect to the identified task, data pattern, or call. Although described herein as having a number of entries, each entry identifying an off-loadable task and a corresponding command, it should be understood that the configuration table 320 may comprise any suitable hardware, software, or combination thereof capable of generating or providing the appropriate command for a detected off-loadable task.

The selection unit 330 determines which off-load device 290 should process a detected off-loadable task. Data from the incoming message stream—or a portion of this data—as well as the command corresponding to the off-loadable task found within the incoming message stream, are forwarded to the selected off-load device 290 for processing. The selection unit 330 may simply distribute off-loadable tasks to the off-load devices 290a-m according to a round robin ordering (i.e., an even distribution amongst all off-load devices 290a-m, irrespective of the load on the off-load devices 290a-m and/or the tasks being off-loaded). Alternatively, as will be described below, the selection unit 330 may employ one or more load balancing mechanisms.

In selecting an off-load device 290, the selection unit 330 may employ transactional load balancing to distribute an off-loadable task to an off-load device 290 based, at least in part, on the current load on each of the off-load devices 290a-m. Transactional load balancing may be suitable where each of the off-load devices 290a-m is capable of processing all off-loadable tasks (i.e., they all have the same capabilities). In lieu of transactional load balancing, or in addition thereto, content-aware load balancing may be employed by the selection unit 330 to distribute an off-loadable task to an off-load device 290 based, at least in part, on the off-loadable task itself. Content-aware load balancing may be suitable where each off-load device 290 is tailored to process a specific type of off-loadable task or a small class of these tasks.

If each of the off-load devices 290a-m is devoted to processing one type of off-loadable task (or class of tasks), the configuration table 320 may, for each off-loadable task, include the off-load device (or devices) that are dedicated to processing that task. When a look-up in the configuration table 320 is performed for an off-loadable task, both the corresponding command and off-load device 290 may be read from the appropriate entry of the configuration table 320. It should be noted, as previously suggested, that two or more off-load devices 290 may be allocated to the processing of one type of off-loadable task and, in such an instance, the selection unit 330 may still perform transactional load balancing amongst these allocated off-load devices 290.

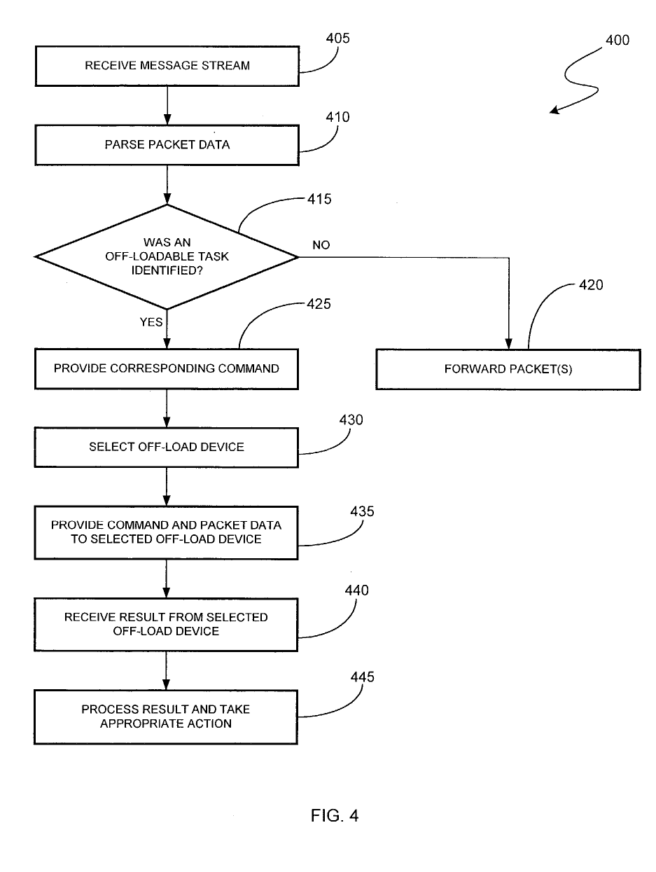

Operation of the server hosting system 200—and, more specifically, of the off-load devices 290a-m and off-load controller 300—may be better understood with reference to FIG. 4. Shown in FIG. 4 is a block diagram illustrating an embodiment of a method of off-loading tasks 400.

Referring to block 405 in FIG. 4, a message stream—again, the message stream may comprise one or more packets—is received at the switch 240. The message stream may be received from a client 10 attempting to establish a connection with the server hosting system 200 or from a client 10 having an established session in progress. Packet data within the message stream is parsed by parsing unit 310 to search for, or otherwise identify, any off-loadable tasks within the received message stream, as shown at block 410. For example, as described above, the parsing unit 310 may search for a data pattern suggesting or indicative of an off-loadable task, or the parsing unit 310 may search for a call or command corresponding to an off-loadable task. Referring to reference numeral 415, it the packet does not include an off-loadable operation, the packet or packets are simply forwarded to the appropriate server 280—see block 420—as determined by switch 240. The switch 240 may perform transactional load balancing and/or content-aware load balancing to determine which of the servers 280a-n should receive the forwarded message stream, such load balancing being independent of any load balancing amongst the off-load devices 290a-m that is performed by the off-load controller 300. Of course, it should be understood, as previously suggested, that one or more of the off-load devices 290a-m, in conjunction with the off-load controller 300, may play a role (e.g., making content routing decisions) in the load balancing amongst the servers 280a-n.

Referring again to reference numeral 415 in FIG. 4, if an off-loadable task is identified in the incoming message stream, the off-load controller 300 may provide a command corresponding to the detected off-loadable task, as illustrated at block 425. The appropriate command may be found by performing a look-up in the configuration table 320, as described above.

Referring to block 430, one of the off-load devices 290a-m is selected by the selection unit 330 to process the detected off-loadable task. Again, the selection unit 330 may utilize transactional and/or content-aware load balancing to select an off-load device 290, or the selection unit 330 may distribute off-loadable tasks in a round robin fashion. Also, as described above, the appropriate off-load device (or devices) 290 may be identified from the configuration table 330, although the selection unit 330 may still perform some load balancing.

As shown at block 435, the off-load controller 300 provides the command and at least a portion of the packet data in the incoming message stream to the selected off-load device 290. The selected off-load device 290 receives the command and packet data and, in response thereto, performs the off-loadable task. As shown at block 440, the selected off-load device 290 may determine a result, which result may be received by the off-load controller 300. The result may be indicative of a content routing decision, a user authentication or validation decision, an XML validation, an XML transformation, or other decision or variable.

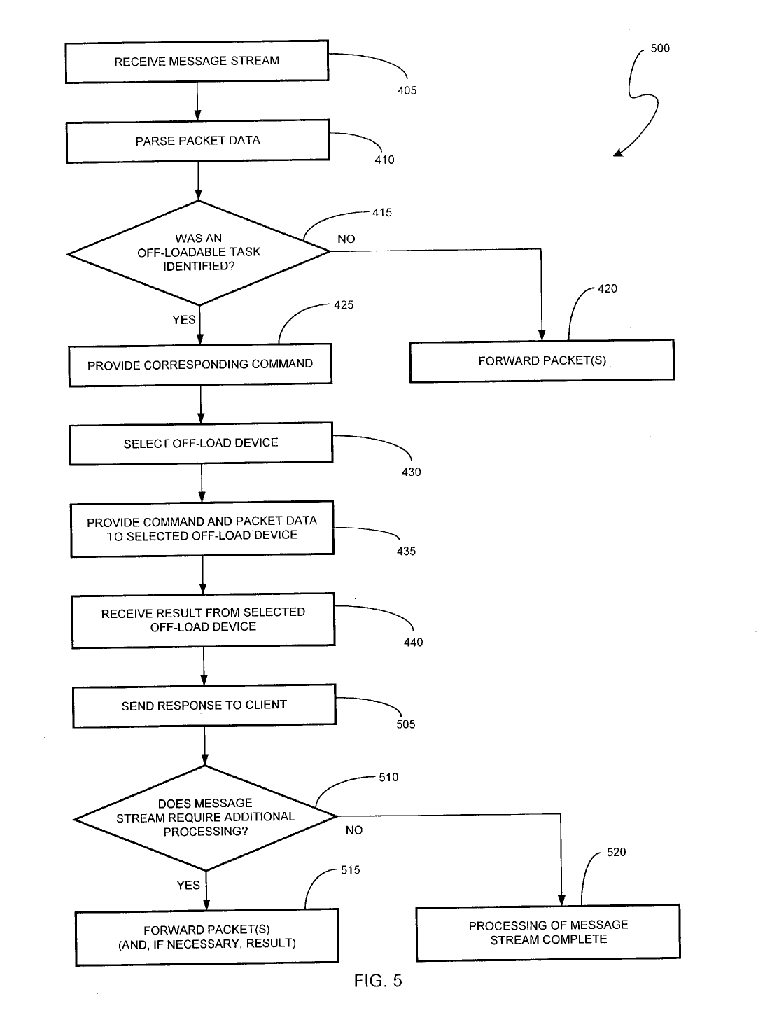

Referring to block 445, the off-load controller 300 (and/or switch 240) will process the result and take any appropriate action. For example, the packet data and, if necessary, the result may simply be forwarded to a server 280 for further processing. The server 280 receiving the packet data and result may have been determined by the selected off-load device 290 executing a content routing operation (or selected by the switch 240 according to other policy, as noted above). By way of further example, the off-load controller 300 may, based upon the result received from the selected off-load device 290, send a response to a client, as may occur during user authentication (see FIG. 5 below).

The method 400 of FIG. 4 is described above in the context of a message stream including a single, identifiable task that is off-loadable. However, it should be understood that a message stream may include any number of off-loadable tasks. If multiple off-loadable tasks (or calls, commands, and/or data patterns suggesting the same) are found within a message stream, a command may be provided for each of the detected off-loadable tasks. An off-load device 290 will be selected to process each of these off-loadable tasks, although a single off-load device 290 may handle two or more of the detected tasks. The off-load controller 300 (and/or switch 240) will receive a result for each off-loadable task being processed and, accordingly, will take appropriate action for each task.

Another embodiment of the method of off-loading tasks 500 is illustrated in FIG. 5. The method 500 illustrated in FIG. 5 is similar to the method 400 shown and described above with respect to FIG. 4, and like elements retain the same numerical designation. Also, a description of those elements described above with respect to FIG. 4 is not repeated in the discussion that follows regarding FIG. 5.

Referring to block 505 in FIG. 5, after a result has been received from the selected off-load device 290 (see block 440), the off-load controller 300 and/or switch 240 sends a response to a client. For example, if the incoming message stream requires a validation operation (e.g., XML validation), and the validation task was off-loaded to the selected off-load device 290 for processing, the response sent to the client may indicate that the message stream data was invalid. Thus, an off-loadable task—in this particular instance, a validation operation—may be performed without involvement of the server cluster 280a-n. However, referring now to reference numeral 510, if the message stream does require further processing, the packet or packets and, if necessary, the result may be forwarded to an appropriate server 280, as shown at block 515. If the message stream does not require additional action, processing is complete, as denoted at block 520.

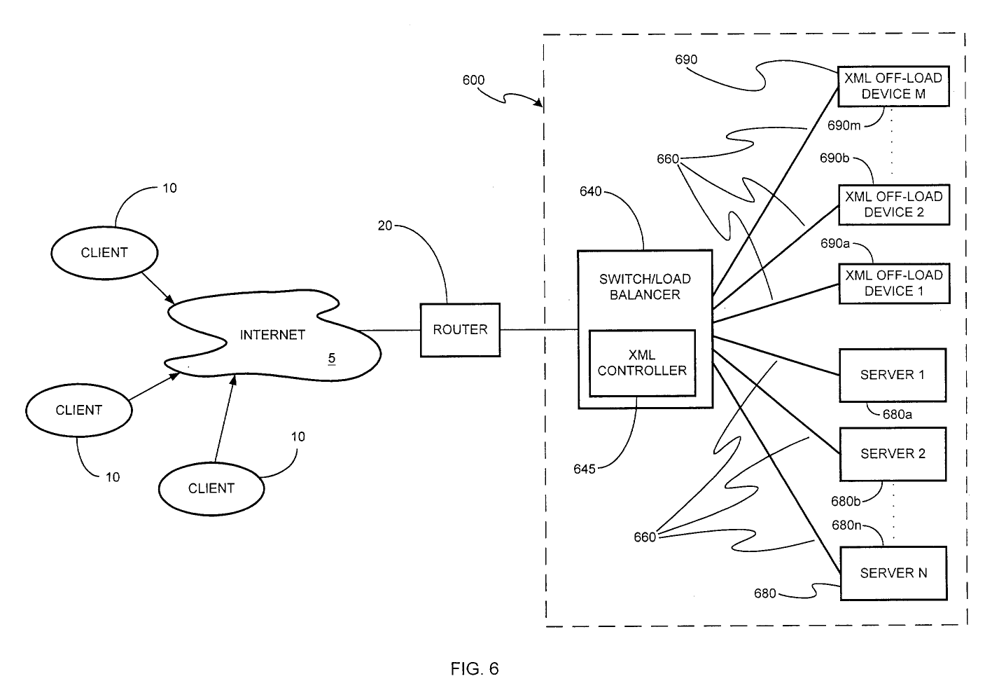

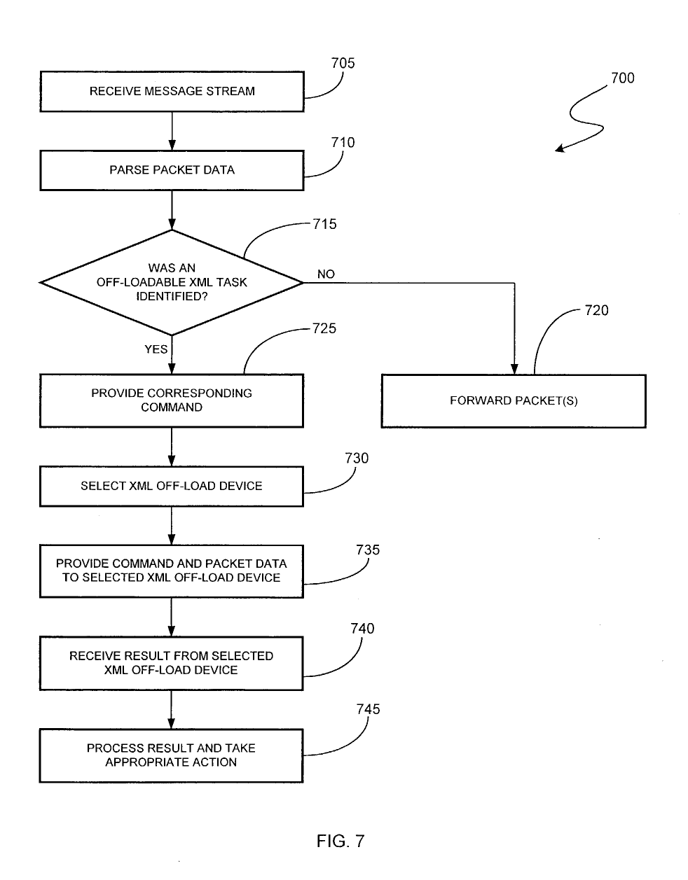

Illustrated in FIG. 6 is an embodiment of a server hosting system 600 that utilizes a number of off-load devices to off-load a specified class of off-loadable tasks. More particularly, the server hosting system 600 off-loads XML processing to XML off-load devices 690. Similarly, illustrated in FIG. 7 is an embodiment of a method of off-loading XML processing 700. One of ordinary skill in the art will appreciate the utility of this example of off-loading tasks to one or more off-load devices, as the number of applications being developed based upon, or to make use of, the XML markup language is rapidly expanding.

Referring to FIG. 6, the server hosting system 600 is coupled with a router 20 that, in turn, is coupled with the Internet 5 or other network. The router 20 may comprise any suitable routing device known in the art, including any commercially available, off-the-shelf router. The server hosting system 600 is accessible by one or more clients 10 that are connected with the Internet 5. Although the server hosting system 600 is illustrated as being coupled with the Internet 5, it should be understood that the server hosting system 600 may be coupled with any computer network, or plurality of computer networks. By way of example, the server hosting system 600 may be coupled with a Local Area Network (LAN), a Wide Area Network (WAN), and/or a Metropolitan Area Network (MAN).

The server hosting system 600 includes a switch and load balancer 640, which is coupled with the router 20. For ease of understanding, the switch and load balancer 640 will be referred to herein as simply a “switch.” The switch 640 includes, or is coupled with, an XML controller 645. The XML controller 645 operates in a manner similar to that described above with respect to the off-load controller 300 illustrated in FIGS. 2 and 3.

The server hosting system 600 also includes one or more servers 680, including servers 680a, 680b, . . . , 680n. Each of the servers 680a-n is coupled with the switch 640 by a link 660, each link 660 providing a point-to-point connection therebetween. Alternatively, a network (not shown in figures) may couple the servers 680a-n with the switch 640. A server 680 may comprise any suitable server or other computing device known in the art, including any one of numerous commercially available, off-the-shelf servers. The server cluster 680a-n is assigned a single IP address, or VIP, and the server cluster 680a-n appears as a single network resource to those clients 10 who are accessing the server hosting system 600.

Also coupled with the switch 640 are a number of XML off-load devices 690, including XML off-load devices 690a, 690b, . . . , 690m. Each XML off-load device 690 is coupled with the switch 640 by a link 660, each link 660 providing a point-to-point connection therebetween. Alternatively, the XML off-load devices 690 may be coupled with the switch 640 by a network (not shown in figures). Any suitable number of XML off-load devices 690 may be coupled with the server hosting system 600. The architecture of server hosting system 600 is scalable and fault-resistant. If additional XML processing capability is needed, an appropriate number of XML off-load devices 690 may simply be added to the server hosting system 600 and, if one of the XML off-load devices 690a-m fails, there will be no disruption in operation of the server hosting system 600, as the failed device's workload can be distributed amongst the remaining XML off-load devices 690.

Each XML off-load device 690 comprises any suitable device or circuitry capable of receiving data and, in accordance with a command received from the XML controller 645 and/or switch 640, performing an XML operation (e.g., validation, transformation, etc.) on that data. A result may be determined by the XML off-load device 690, which result may, in turn, be provided to the XML controller 645 and/or switch 640. An XML off-load device 690 may, for example, comprise a microprocessor, an ASIC, or an FPGA, although it should be understood that such an XML off-load device 690 may comprise a part of, or be integrated with, another device or system (e.g., a server). It should be further understood that an XML off-load device 690 may be implemented in hardware, software, or a combination thereof.

Operation of the server hosting system 600 may be better understood with reference to FIG. 7, which shows a block diagram illustrating an embodiment of a method of off-loading XML processing 700, as noted above. Referring to block 705 in FIG. 7, a message stream (comprising one or more packets) is received at the switch 640. The message stream may be received from a client 10 attempting to establish a connection with the server hosting system 600 or from a client 10 having an established session in progress. The packet data in the message stream is parsed to search for, or otherwise identify, any off-loadable XML task within the received message stream, as shown at block 710. For example, the packet data may be parsed to search for a data pattern suggesting or indicative of an off-loadable XML task, or the packet data may be parsed to search for a call or command corresponding to an off-loadable XML task.

Referring to reference numeral 715, if the message stream does not include an off-loadable XML task, the packet or packets are simply forwarded to the appropriate server 680—see block 720—as determined by switch 640. The switch 640 may perform transactional load balancing and/or content-aware load balancing to determine which of the servers 680a-n should receive the forwarded message stream. Again, it should be understood that such load balancing may be independent of any load balancing amongst the XML off-load devices 690a-m being performed by the XML controller 645 and, further, that one or more of the XML off-load devices 690 (or other off-load device), in conjunction with XML controller 645, may play a role (e.g., making content routing decisions) in the load balancing amongst the servers 680a-n.

Referring again to reference numeral 715 in FIG. 7, if an off-loadable XML task is identified in the incoming message stream, the XML controller 645 may provide a command corresponding to the detected XML operation, as illustrated at block 725. The appropriate command may be found by performing a look-up in a configuration table of the XML controller 645, as described above.

Referring to block 730, one of the XML off-load devices 690a-m is selected to process the detected off-loadable XML task. As previously described, transactional and/or content-aware load balancing may be employed to select an XML off-load device 690, or off-loadable XML tasks may be distributed to the XML off-load devices 690a-m in a round robin fashion. Also, as described above, the appropriate XML off-load device (or devices) 690 may be identified from a configuration table in XML controller 645, although some load balancing may still be performed.

As shown at block 735, the XML controller 645 provides a the command and at least a portion of the packet data in the incoming message stream to the selected XML off-load device 690. The selected XML off-load device 690 receives the command and packet data and, in response thereto, performs the XML task. As shown at block 740, the selected XML off-load device 690 may determine a result, which result may be received by the XML controller 645. Referring to block 745, the XML controller 645 (and/or switch 640) will process the result and take any appropriate action. The packet data and, if necessary, the result may be forwarded to a server 680 for further processing.

By way of example, and without limitation, XML processing that may be performed by the XML off-load devices 690 includes validation and transformation. An XML document is “well-formed” if it obeys the syntax of the XML standard, and a well-formed XML documents is “valid” if it contains a proper document type definition and/or schema. When a data packet or packets are received that represents an XML document, it may be desirable to verify that the XML document is valid prior to sending the data to an application server 680. To perform such an XML validation operation, the XML controller 645 will send the packet data, which includes an XML data stream, and the corresponding validation command (e.g., “<validation/>”) to the selected XML off-load device 690. The selected XML off-load device 690 will process the message and return back to the XML controller 745 either a valid (e.g., “<valid/>”) or invalid (e.g., “<invalid/>”) response.

It may also be necessary to transform a stream of XML data into another format in accordance with a defined template or stylesheet. To perform a transformation between different XML data formats, the XML controller 645 will send a packet or packets and a transformation instruction (e.g., “<transform/>”) to the selected XML off-load device 690. The selected XML off-load device 690 will perform the transformation and return a transformed XML data stream or document back to the XML controller 645.

The method 700 of FIG. 7 is described above in the context of a packet including a single, identifiable XML task that is off-loadable. However, it should be understood that a message stream may include any number of off-loadable XML tasks. If multiple off-loadable XML tasks (or calls, commands, and/or data patterns suggesting the same) are found within a message stream, a command may be provided for each of the detected off-loadable XML tasks. An XML off-load device 690 will be selected to process each of these off-loadable XML tasks, although a single XML off-load device 690 may handle two or more of the detected operations. The XML controller 645 (and/or switch 640) will receive a result for each off-loadable XML tasks being processed and, accordingly, will take appropriate action for each operation. It should be further understood that the server hosting system 600—including XML off-load devices 690a-m—is not limited to the off-loading of XML processing, as non-XML operations may also be off-loaded to the XML off-load devices 690 (or other off-load devices).

Embodiments of a server hosting system including a number of off-load devices—as well as embodiments of a method of off-loading tasks to an off-load device—having been herein described, those of ordinary skill in the art will appreciate the advantages thereof. Allocating the processing of a set of off-loadable tasks to a number of off-load devices preserves computing resources of a server hosting system, such that these resources (e.g., an application server or server cluster) may be more efficiently utilized for servicing client requests and performing other tasks. Also, a server hosting system having a number of off-load devices according to the disclosed embodiments is easily scalable and highly fault-tolerant.

The foregoing detailed description and accompanying drawings are only illustrative and not restrictive. They have been provided primarily for a clear and comprehensive understanding of the disclosed embodiments and no unnecessary limitations are to be understood therefrom. Numerous additions, deletions, and modifications to the embodiments described herein, as well as alternative arrangements, may be devised by those skilled in the art without departing from the spirit of the disclosed embodiments and the scope of the appended claims.

What is claimed is:

1. A method comprising:
identifying off-loadable tasks in a received message stream, the received message stream including data; and
if an off-loadable task is identified,
selecting an off-load device, and
providing at least a portion of the data to the selected off-load device.

2. The method of claim 1, further comprising:
if an off-loadable task is identified, providing a command corresponding to the identified off-loadable task to the selected off-load device.

3. The method of claim 1, further comprising receiving a result from the selected off-load device.

4. The method of claim 3, further comprising forwarding the result and the data to a server.

5. The method of claim 3, further comprising sending a response to a client.

6. The method of claim 1, further comprising:
if an off-loadable task is not identified, providing the data to a server.

7. The method of claim 1, further comprising selecting the off-load device according to a round robin ordering.

8. The method of claim 1, further comprising selecting the off-load device using transactional load balancing.

9. The method of claim 1, further comprising selecting the off-load device using content-aware load balancing.

10. A method comprising:
searching a received message stream for a data pattern corresponding to an off-loadable task, the received message stream including data; and
if the message stream includes the data pattern,
selecting an off-load device, and
providing at least a portion the data to the selected off-load device.

11. The method of claim 10, further comprising:
if the received message stream includes the data pattern, providing a command corresponding to the off-loadable task to the selected off-load device.

12. The method of claim 10, further comprising receiving a result from the selected off-load device.

13. The method of claim 12, further comprising forwarding the result and the data to a server.

14. The method of claim 12, further comprising sending a response to a client.

15. The method of claim 10, further comprising:
if the received message stream does not include the off-loadable task, providing the data to a server.

16. The method of claim 10, further comprising selecting the off-load device according to a round robin ordering.

17. The method of claim 10, further comprising selecting the off-load device using transactional load balancing.

18. The method of claim 10, further comprising selecting the off-load device using content-aware load balancing.

19. A method comprising:
searching a received message stream for a call corresponding to an off-loadable task, the message stream including data; and
if the received message stream includes the call,
selecting an off-load device, and
providing at least a portion of the data to the selected off-load device.

20. The method of claim 19, further comprising:
if the received message stream includes the call, providing a command corresponding to the off-loadable task to the selected off-load device.

21. The method of claim 19, further comprising receiving a result from the selected off-load device.

22. The method of claim 21, further comprising forwarding the result and the data to a server.

23. The method of claim 21, further comprising sending a response to a client.

24. The method of claim 19, further comprising:
if the received message stream does not include the call, providing the data to a server.

25. The method of claim 19, further comprising selecting the off-load device according to a round robin ordering.

26. The method of claim 19, further comprising selecting the off-load device using transactional load balancing.

27. The method of claim 19, further comprising selecting the off-load device using content-aware load balancing.

28. A method comprising:
identifying off-loadable XML tasks in a received message stream, the received message stream including data; and
if an off-loadable XML task is identified,
selecting an off-load device, and
providing at least a portion of the data to the selected off-load device.

29. The method of claim 28, further comprising:
if an off-loadable XML task is identified, providing a command corresponding to the off-loadable XML task to the selected off-load device.

30. The method of claim 28, further comprising receiving a result from the selected off-load device.

31. The method of claim 30, further comprising forwarding the result and the data to a server.

32. The method of claim 30, further comprising sending a response to a client.

33. The method of claim 28, further comprising:
if an off-loadable XML task is not identified, providing the data to a server.

34. The method of claim 28, further comprising selecting the off-load device according to a round robin ordering.

35. The method of claim 28, further comprising selecting the off-load device using transactional load balancing.

36. The method of claim 28, further comprising selecting the off-load device using content-aware load balancing.

37. The method of claim 28, wherein the off-loadable XML tasks include XML validation and XML transformation.

38. A system comprising:
a number of off-load devices, each of the off-load devices coupled with a switch;
a server coupled with the switch; and
an off-load controller coupled with the switch, the off-load controller to identify off-loadable tasks in a received message stream and, if an off-loadable task is identified,
select an off-load device from the number of off-load devices, and
provide at least a portion of data contained in the received message stream to the selected off-load device.

39. The system of claim 38, the off-load controller to provide a command corresponding to the identified off-loadable task to the selected off-load device.

40. The system of claim 38, the off-load controller to receive a result from the selected off-load device.

41. The system of claim 40, the off-load controller to forward the result and the data to the server.

42. The system of claim 40, the off-load controller to send a response to a client.

43. The system of claim 38, the off-load controller to provide the data to the server if an off-loadable task is not identified.

44. The system of claim 38, the off-load controller to select the off-load device according to a round robin ordering.

45. The system of claim 38, the off-load controller to select the off-load device using transactional load balancing.

46. The system of claim 38, the off-load controller to select the off-load device using content-aware load balancing.

47. The system of claim 38, the off-load controller, when identifying an off-loadable task, to search the received message stream for a data pattern corresponding to the off-loadable task.

48. The system of claim 38, the off-load controller, when identifying an off-loadable task, to search the received message stream for a call corresponding to the off-loadable task.

49. The system of claim 38, wherein the off-load controller forms a part of the switch.

50. The system of claim 38, the off-load controller comprising:
a parsing unit to identify the off-loadable tasks in the received message stream; and
a selection unit to select the off-load device to process an identified off-loadable task.

51. The system of claim 50, the off-load controller further comprising a configuration table including a number of entries, each of the entries identifying an off-loadable task and a corresponding command.

52. The system of claim 51, wherein each of the entries further identifies a corresponding off-load device.

53. The system of claim 38, wherein the off-load controller is coupled with a network.

54. The system of claim 53, the network comprising the Internet.

55. The system of claim 38, at least one of the off-load devices comprising an XML off-load device.

56. An article of manufacture comprising:
a medium having content that, when accessed by a device, causes the device to identify off-loadable tasks in a received message stream, the received message stream including data; and
if an off-loadable task is identified,
select an off-load device, and
provide at least a portion of the data to the selected off-load device.

57. The article of manufacture of claim 56, wherein the content, when accessed, further causes the device to:
if an off-loadable task is identified, provide a command corresponding to the identified off-loadable task to the selected off-load device.

58. The article of manufacture of claim 56, wherein the content, when accessed, further causes the device to receive a result from the selected off-load device.

59. The article of manufacture of claim 58, wherein the content, when accessed, further causes the device to forward the result and the data to a server.

60. The article of manufacture of claim 58, wherein the content, when accessed, further causes the device to send a response to a client.

61. The article of manufacture of claim 56, wherein the content, when accessed, further causes the device to:
if an off-loadable task is not identified, provide the data to a server.

62. The article of manufacture of claim 56, wherein the content, when accessed, further causes the device to select the off-load device according to a round robin ordering.

63. The article of manufacture of claim 56, wherein the content, when accessed, further causes the device to select the off-load device using transactional load balancing.

64. The article of manufacture of claim 56, wherein the content, when accessed, further causes the device to select the off-load device using content-aware load balancing.
